(19) United States
(12) Patent Application Publication
(10) Pub. No.: US 2014/0061265 A1
(43) Pub. Date: Mar. 6, 2014

(54) Cargo Support

(71) Applicant: Michael E. Mendonça, San Francisco, CA (US)

(72) Inventor: Michael E. Mendonça, San Francisco, CA (US)

(21) Appl. No.: 13/972,350

(22) Filed: Aug. 21, 2013

Related U.S. Application Data
(60) Provisional application No. 61/696,162, filed on Sep. 1, 2012.

(51) Int. Cl. B60R 9/06

(52) U.S. Cl. CPC B60R 9/06
USPC 224/403

(57) ABSTRACT

A mounting device including one or more longitudinal support members slidably coupled to said longitudinal support member, and at least one pinch bracket, said pinch bracket having at least one elongated portion, said elongated portion at least partially disposed inside the lateral support member. The pinch bracket may be disposed around one of the longitudinal support members and formed so that a portion is the same shape as the longitudinal support member and fits over the exterior of the longitudinal support member. The support members may be formed from extruded plastic or extruded metal and include a support structure for holding the bracket in place.

### PRIORITY

This application is utility application of co-pending provisional patent application 61/696,162 entitled “Cargo Support” filed Sep. 1, 2012 by the same inventor which, together with its Appendix, is incorporated by reference as if fully disclosed herein.

### BACKGROUND

The present invention relates generally to support structures, and more particularly to a support structure for securing cargo in place during transit.

Often people place cargo on a flatbed vehicle for shipment. For example on the back of a pickup truck. The problem with placing cargo on the back of a pickup truck is that while the vehicle is moving the cargo slides around and may get damaged during shipment. There are several commercially available approaches towards solving this problem such as tie-downs and support webbing and other techniques to try to secure a small piece of cargo on a large flat bed. However, depending on the nature of the cargo, theses supports don't do an adequate job of holding the cargo in place during transit. Also, since the size of the cargo is not often known in advance, proper equipment to secure the cargo is difficult to find. Accordingly what is needed is an improved support structure for securing cargo in place during transit on a flatbed vehicle.

### SUMMARY

Disclosed herein is a cargo support system for mounting onto the bed of a flat-bed carrier vehicle. The cargo support is adjustable to fit a wide variety of cargo types. The support members of the cargo support may be effectuated using hollow support members formed from extruded plastic or other suitable material. A spring bracket stamped to have a portion for grasping one support member radially, and a second portion for insertion axially into a second support member. The bracket may be placed around one support member, and pressure fit into a hollow core of a second support member. The second support member may have internal ribs for holding a portion of the bracket. The cargo support is adjustable by repositioning the brackets and their associated support members.

In operation a user installs one or more longitudinal support members by affixing them to the bed of a vehicle. The user then installs one or more lateral support members and positions them to suit the intended cargo. Cargo, when placed into the bed of the vehicle, will be prevented from sliding around as the vehicle moves. As the type of cargo changes, the positions of the lateral support members may be easily changed to suit the cargo.

Some embodiments may include amounting device including one or more longitudinal support members slidably coupled to said longitudinal support member, and at least one pinch bracket, said pinch bracket having at least one elongated portion, said elongated portion at least partially disposed inside the lateral support member. The pinch bracket may be disposed around one of the longitudinal support members and formed so that a portion is the same shape as the longitudinal support member and fits over the exterior of the longitudinal support member. The support members may be formed from extruded plastic or extruded metal and include a support structure for holding the bracket in place.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates one embodiment of an aspect of a cargo support.

FIG. 2 shows a functional drawing of the operation of a bracket.

FIG. 3 shows a portion of an embodiment of an assembled cargo support.

FIG. 4 shows one embodiment of the cargo support.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

### DETAILED DESCRIPTION

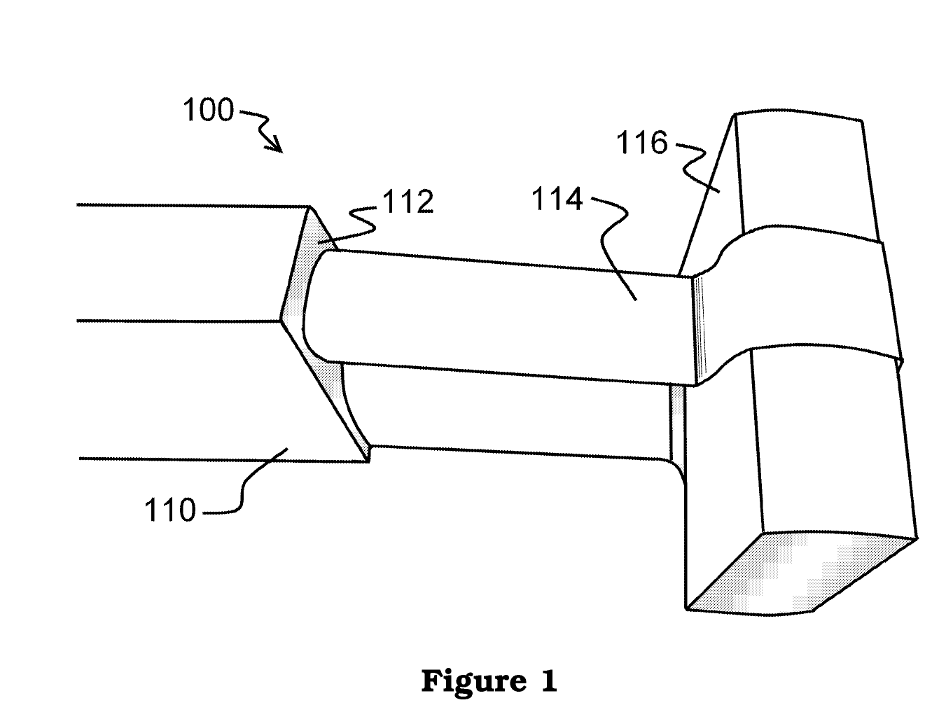

FIG. 1 illustrates one embodiment of an aspect of a cargo support 100. In FIG. 1 a lateral support member 110 is formed to expose an opening 112 at one end of the lateral support member 110. The lateral support member 110 may be formed from any suitable material, for example and without limitation, extruded plastic or extruded aluminum, as long as the material is capable of handling the load and can be formed to have the opening 112 available for use. The lateral support member 110 may typically be formed having a hollow running the whole length of the lateral support member 110 therefore providing the opening 112. While the inventor contemplates using support members that are approximately the size of commercial lumber, such as 2×4s and the like, there is no requirement that support members have any particular size.

A longitudinal support member 116 is also shown in FIG. 1. The longitudinal support member 116 may be solid or hollow depending on the needs of the application. A bracket 114 is formed to have a first portion substantially the shape of the longitudinal support member 116. The bracket 114 are also has two extended portions that are sized to fit into the opening 112. The extended members are shown integrally formed as part of the bracket 114. The inventor contemplates using spring steel, aluminum, plastic or some other material such that the bracket 114 is operable to exert some pressure on the lateral support member 110 when the elongated members of the bracket 114 are placed into the lateral support member 110. Accordingly the bracket 114 is formed such that the elongated members spread out to be slightly larger than the opening 112. Alternatively the opening 112 may have ribs or other support structure embedded inside the opening 112 to facilitate operation with the bracket 114. The bracket 114 operates as a pinch bracket in that when the elongated members are brought close together, the bracket 114 pinches the longitudinal support member 116 holding it in place.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

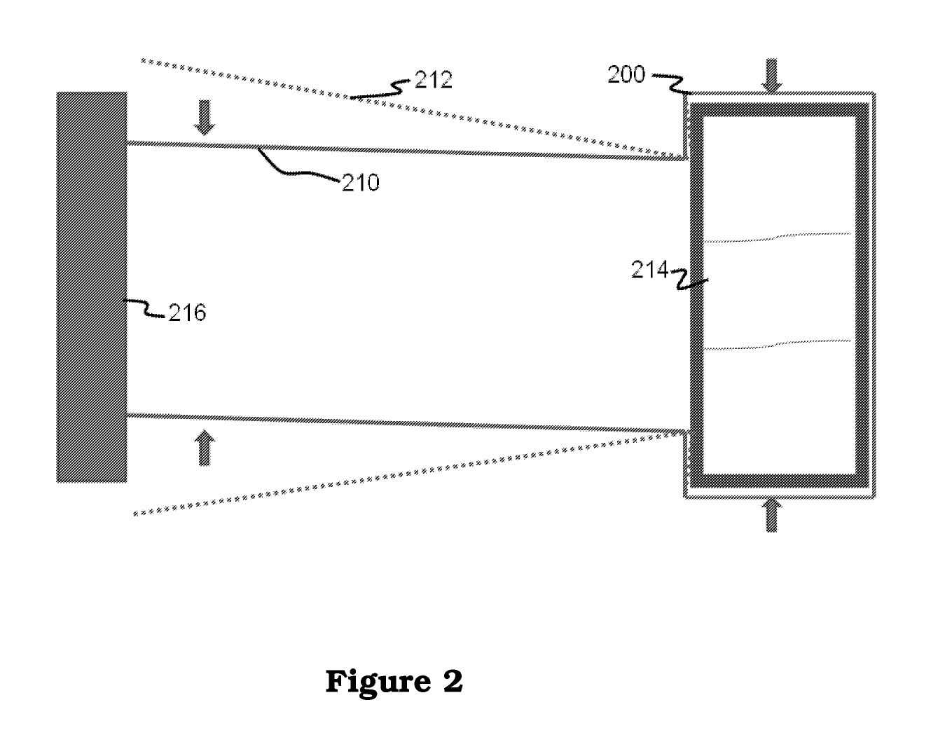

FIG. 2 shows a functional drawing of the operation of a bracket 200. A bracket 200 is shown in two positions, 210 and 212. In a first position 212, the bracket 200 is shown in an “open” position. During operation, a user squeezes the bracket's 200 elongated portions such that the bracket seats firmly about the support member 214. Proper fit may be effectuated by stamping the bracket 200 to be approximately the same size as the support member 214. Once pressed together, the bracket 200 is in the “closed” position 210. In the closed position the elongated portion of the bracket 200 may be inserted into a second support structure 216 through an opening (not shown) on the second support structure 216.

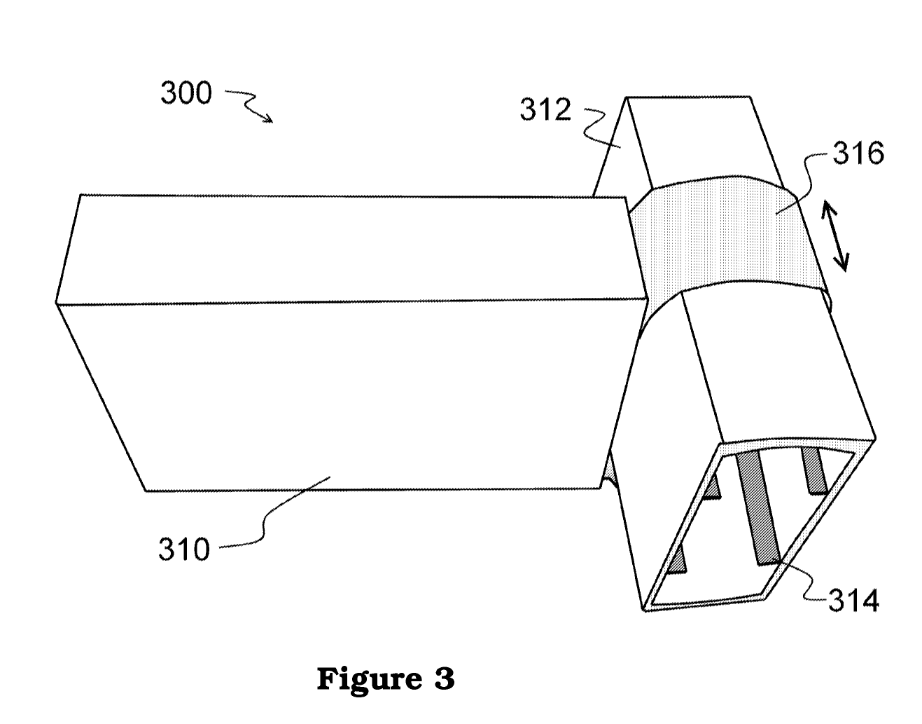

FIG. 3 shows a portion of an embodiment of an assembled cargo support 300. In FIG. 3 a lateral support member 310 is formed with a hollow interior (not shown). A bracket 316 is formed around a longitudinal support member 312. The bracket 316 has two elongated members (not shown) which are pressure fit into the hollow interior of the lateral support member 310. In operation the lateral support member may be repositioned by sliding it to the side so the elongate members are not inside the hollow of lateral support member 316, thus loosening the grip by the bracket 316 on the longitudinal support member 312. Then the lateral support member 310 may be repositioned axially along the axis of longitudinal support member 312.

In certain embodiments the support members may have an internal structure 314 for holding in place the bracket 316. The internal structure may be formed of “ribs” or ledges attached to the interior walls of the support member. The amount, position, and size of the internal structures 314 may be adjusted to conform to different types of brackets and different amounts of support required. Other internal structures may include supports extending across the complete hollow of the internal cavity.

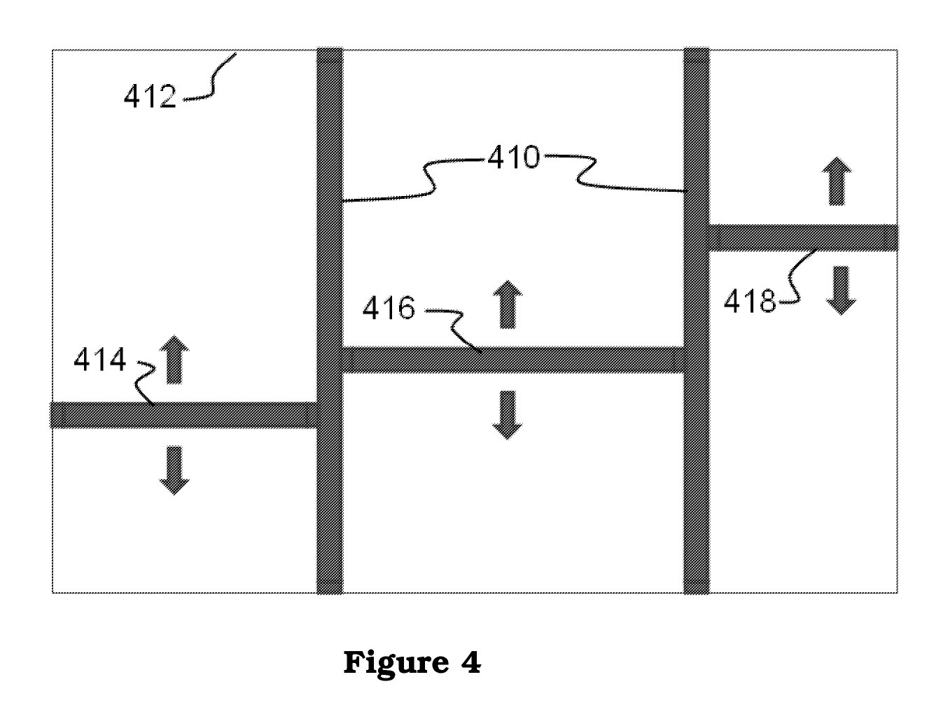

FIG. 4 shows one embodiment of the cargo support. In FIG. 4 multiple longitudinal support members 410 are affixed to the bed of a vehicle 412. The bed may be the bed of a pickup truck, the carrying surface of a “stake side” truck, the floor of a van or other similar conveyance having a flat surface for carrying cargo. Attached to the support members 410 using the methods described herein are 3 lateral members 414, 416 and 418. The position of the lateral support members is completely adjustable within the framework of the longitudinal support members 410 by sliding the support members in relation to other support members.

In operation a user may install one or more longitudinal support members 410 by affixing them to the bed, (or walls of the bed) of a vehicle 412. The user then installs one or more lateral support members and positions them to suit the intended cargo. Moreover, in operation as the cargo changes, the positions of the lateral support members may be easily changed. Alternatively the user may simply lay the members onto a flat surface and allow for the weight of the members to hold them into position.

Longitudinal support members may be affixed to the walls of the truck bed through the use of plastic or rubber end caps thus providing for pressure fitting. Commercially available end caps with bellows may be inserted into the ends of the longitudinal support members to provide a pressure fit to the walls of the bed. In some embodiments commercially available end caps that fit over the ends of the support members may also be employed. In certain embodiments adjustable sleeves of caps may be employed to allow for variations in the width of truck bed walls.

In other embodiments, longitudinal support members may be affixed to the flat surface of a bed. For example and without limitation when a bed has no side walls to affix a longitudinal support member to. While the inventor contemplates affixing a support member to a side wall, this disclosure should not be read as requiring that limitation. For example and without limitation, the longitudinal and lateral support members may be employed without affixing them to any bed or wall of a bed. In these embodiments the support members operate as self-supporting because they are affixed together. Any cargo would further operate to hold the embodiment in place. In some embodiments it may be preferable to affix a single support member to the vehicle.

The above illustration provides many different embodiments or embodiments for implementing different features of the invention. Specific embodiments of components and processes are described to help clarify the invention. These are, of course, merely embodiments and are not intended to limit the invention from that described in the claims.

Furthermore, this application includes an appendix which is included in its entirety by reference as if fully set forth herein.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A device comprising:
one or more longitudinal support members;
at least one lateral support member, slidably coupled to said longitudinal support member, and
at least one pinch bracket, said pinch bracket having at least one elongated portion, said elongated portion at least partially disposed inside the lateral support member.

2. The device of claim 1 where the pinch bracket is disposed about at least one of the longitudinal support members.

3. The device of claim 1 wherein the pinch bracket is formed so that a portion is substantially the same shape as the longitudinal support member and fits over the exterior of the longitudinal support member.

4. The device of claim 1 where the support members are formed from extruded plastic or extruded metal.

5. The device of claim 1 wherein either the longitudinal or the lateral support member includes a support structure, said support structure disposed inside the support member.

6. The device of claim 1 wherein either the longitudinal support or the lateral support is affixed to a vehicle.

7. The device of claim 6 wherein the vehicle is a truck.

8. A device comprising:
a first member, said first member having a height and width;
a second member, said second member having substantially the same height and width as the first member;
a bracket, said bracket having a portion substantially the height of the first member and a second portion of substantially the width of the first member, said bracket disposed about the first member, said bracket further including a third portion extending substantially orthogonally away from a surface of the first member,
wherein the third portion is disposed into a hollow of the second member.

9. The device of claim 8 wherein the first or second member are formed from extruded plastic.

10. The device of claim 8 wherein either the first or the second member are formed from extruded aluminum.

11. The device of claim 8 wherein the bracket is formed from a single piece of material formed to include a fourth portion extending substantially parallel to the third portion, said fourth portion disposed into a hollow of the second member.

12. The device of claim 11 wherein the bracket is formed from spring steel.

13. The device of claim 11 wherein the bracket is formed from plastic.

14. The device of claim 11 wherein the hollow in the second member includes a support structure.

15. The device of claim 14 wherein the third and fourth portions abut the support structure.
